(19) United States
(12) Patent Application Publication
(10) Pub. No.: US 2026/0250589 A1
(43) Pub. Date: Aug. 27, 2026

(54) METHOD FOR PROMOTING COMBUSTION OF COMBUSTIBLE AND ENHANCING POWER OUTPUT AND USAGE LIFE OF COMBUSTION EQUIPMENT

(71) Applicant: Qingdao Hengnengda Energy Technologies Co., Ltd., Shandong (CN)

(72) Inventor: Yongheng ZHANG, Qingdao (CN)

(73) Assignee: Qingdao Hengnengda Energy Technologies Co., Ltd., Shandong (CN)

(21) Appl. No.: 19/674,462

(22) Filed: May 12, 2026

Related U.S. Application Data
(63) Continuation-in-part of application No. PCT/CN2024/119696, filed on Sep. 19, 2024.

(30) Foreign Application Priority Data
Nov. 16, 2023 (CN) 202311528556.3

(51) Int. Cl. C10L 9/10; C10L 3/00; C10L 5/00

(52) U.S. Cl. CPC C10L 9/10; C10L 3/003; C10L 5/00; C10L 2200/0209; C10L 2200/0213; C10L 2270/04; C10L 2300/20

(57) ABSTRACT

A method for promoting combustion of a combustible and enhancing a power output and a usage life of a combustion equipment by adding an alkali metal element and/or an alkaline earth metal element into the combustible is disclosed. A matter state of the combustible includes at least one of gas, liquid, and solid; the alkali metal element includes one or more of Li, Na, K, Rb, Cs, and Fr; and the alkaline earth metal element includes one or more of Be, Mg, Ca, Sr, Ba, and Ra.

### CROSS REFERENCE TO RELATED APPLICATION

The present application is a continuation application of International Patent Application No. PCT/CN2024/119696, filed on Sep. 19, 2024, which claims priority to Chinese Patent Application No. 202311528556.3, entitled “Method for promoting combustion of combustible materials, improving power output of combustion device and prolonging service life of combustion device”, and filed with the China National Intellectual Property Administration on Nov. 16, 2023. The disclosure of the two applications is incorporated by references herein in their entireties as part of the present application.

### TECHNICAL FIELD

This disclosure relates to combustion promotion technology, particularly relates to a method for promoting the combustion of a combustible and enhancing a power output and a usage life of a combustion equipment. This disclosure promotes the combustion of a combustible and enhances a power output and a usage life of a combustion equipment by adding an alkali metal element and/or an alkaline earth metal element into the combustible. This disclosure provides a fuel and a combustion equipment, including a fuel and a reactor for nuclear fusion or nuclear fission, which promotes the combustion of a combustible and enhances a power output and a usage life of a combustion equipment. Importantly, the disclosed fuel or combustion equipment can prevent explosive combustion. By using the method, the combustion efficiency of the combustible, the power output and usage life of the combustion equipment can be significantly enhanced, and meanwhile the safety during the combustion can be improved significantly.

### BACKGROUND ART

The existing technology believes that a combustion is a violent, luminous, and exothermic chemical reaction that occurs between the combustible and combustion-supporting material. The characteristic of combustion-supporting material is its ability to support the combustion. When a piece of paper burns in oxygen, the oxygen has a combustion supporting property. When a piece of magnesium burns in carbon dioxide, the carbon dioxide has combustion supporting property. The combustion-supporting material does not have a combustibility, and the combustible does not have a combustion supporting property. The combustible and combustion-supporting material are interdependent. Both combustible and combustion-supporting material are necessary for combustion.

The existing technology believes that the combustion-supporting material can increase the combustion performance and improve combustion efficiency, and they are generally considered as oxidants. For example, the oxygen is used as the oxidant in the combustion of daily life. The combustion-supporting materials can also be added into various fuels for various combustion equipment such as industrial boiler, car and ship engine, jet engine, or rocket engine, or be added into explosive and gunpowder, etc.

It is believed in prior arts that the combustion efficiency, power output, noise, vibration and usage life are only related to combustion process. In the past 100 years, the improvement of combustion efficiency, power output, noise and vibration, and usage life of combustion equipment is usually based on the design of combustion equipment structure. The promotion of the combustion process is usually achieved by adding the oxidants without considering the interaction between the fuel and combustion equipment during the combustion. However, the improvement of combustion, power output and usage life of the combustion equipment is not significant.

### SUMMARY

In view of the above, this disclosure provides a method for promoting the combustion of a combustible and enhance power output and prolong usage life of a combustion equipment. The method according to this disclosure has a principle completely different from those of existing combustion promotion technologies. In the method, an alkali metal element and/or an alkaline earth metal element is added to promote the formation of plasma, thereby promoting the combustion of the combustible and enhancing the power output and usage life of the combustion equipment.

In order to achieve above technical purpose, this disclosure provides following technical solutions:

A method for promoting combustion of a combustible and enhancing a power output and a usage life of a combustion equipment by adding an alkali metal element and/or an alkaline earth metal element into the combustible. A matter state of the combustible includes at least one selected from the group consisting of gas, liquid, and solid. The alkali metal element includes one or more selected from the group consisting of Li, Na, K, Rb, Cs, and Fr, and the alkaline earth metal element includes one or more selected from the group consisting of Be, Mg, Ca, Sr, Ba, and Ra.

The method according to this disclosure is applicable to all combustibles.

In some embodiments, the combustible includes one or more selected from the group consisting of carbon, a carbon-containing organic matter, hydrogen, deuterium, tritium, ammonia, a metal, sulfur, and phosphorus.

The disclosed technology is applicable to all combustion equipment, for example, gasoline engine, diesel engine, internal combustion engine, external combustion engine, piston engine, ammonia-mixed fuel-powered piston engine, hydrogen-mixed fuel-powered piston engine, mixed fuel-powered piston engine, piston engine, turbofan engine, turbojet engine, rocket engine, gas turbine, mixed fuel-powered gas turbine, boiler, nuclear fusion reactor, nuclear fission reactor, fuel cell, warmer, oven, thermoelectric conversion device, or heat-cold conversion device.

In some embodiments, the alkali metal element and/or the alkaline earth metal element is added in a form including at least one selected from the group consisting of atom, ion, and plasma.

In some embodiments, the alkali metal element and/or the alkaline earth metal element is added in a form of any matter containing the alkali metal element and/or the alkaline earth metal element.

In some embodiments, a matter containing the alkali metal element and/or the alkaline earth metal element includes one or more selected from the group consisting of an elementary substance, an alloy, a compound, and a composition containing the alkali metal element and/or the alkaline earth metal element, and a matter state of the matter containing the alkali metal element and/or the alkaline earth metal element includes one selected from the group consisting of gas, liquid, solid, and plasma.

In some embodiments, the alkali metal element and/or the alkaline earth metal element is added in an amount of 0 wt %-100000.9999999999999999 wt %, but not being 0 wt %, of a mass of the combustible.

In some embodiments, the alkali metal element and/or the alkaline earth metal element is added in an amount of 0 wt %-90.9999999999999999 wt %, but not being 0 wt %, of the mass of combustible.

In some embodiments, an approach for adding the alkali metal element and/or the alkaline earth metal element into the combustible includes at least one selected from the group consisting of approach I, approach II, approach III, and approach IV.

The approach I includes: subjecting the matter containing the alkali metal element and/or the alkaline earth metal element to melting, electrical sparking, plasmizating, stirring, ball milling or pulverizing, and then adding a resulting material to the combustible; or mixing a matter containing the alkali metal element and/or the alkaline earth metal element with a noncombustible, and then adding a resulting mixture to the combustible, where the noncombustible includes all kinds of noncombustibles.

The approach II includes: dissolving a matter containing the alkali metal element and/or the alkaline earth metal element in the combustible.

The approach III includes: mixing a matter containing the alkali metal element and/or the alkaline earth metal element with a solvent to obtain a solution, a suspension or a paste, and adding the solution, the suspension, or the paste to the combustible.

The approach IV includes: adding a matter containing the alkali metal element and/or the alkaline earth metal element into a component of the combustion equipment, wherein an alkali metal element or an alkaline earth metal element in the component reacts with the combustible or a noncombustible to generate a substance containing the alkali metal element or the alkaline earth metal element and thereby is added to the combustible.

In some embodiments, in approach IV, the component of the combustion equipment includes one or more selected from the group consisting of a combustion chamber, or a piston, a connecting rod of a piston, a cylinder sleeve, a nozzle, a spark plug, a rotor, a blade, a gear, a bearing, a screw, a bolt inside the combustion chamber, a container for a lubricating oil, a container for a fuel, and a container for a combustion-supporting substance, a delivery pipeline, and a filter.

In some embodiments, in approach IV, the component of the combustion equipment is made of a material containing the alkali metal element and/or the alkaline earth metal element; the material containing the alkali metal element and/or the alkaline earth metal element include one or more selected from the group consisting of a polymer, a ceramic, and a metal; and a content of the alkali metal element and/or the alkaline earth metal element in the material containing the alkali metal element and/or the alkaline earth metal element is in a range of 0 wt %-99.990000000000 wt %, excluding 0 wt %.

In some embodiments, the polymer includes rubber; the metal includes an elementary substance of a metal and/or an alloy; a content of the alkali metal element and/or the alkaline earth metal element in the alloy is in a range of 0.00000000001 wt %-99.99 wt %.

This disclosure further provides a combustion equipment. During the combustion, the alkali metal element and/or the alkaline earth metal element react with the combustible to generate a carbon-containing material on a surface of the combustion equipment, and the carbon-containing material is a substance containing the alkali metal element and/or the alkaline earth metal element. Therefore, in this disclosure, a depression, a protrusion, or a hole is configured in the component of the combustion equipment, such that matters containing the alkali metal element and/or the alkaline earth metal element with different chemical compositions and structures are generated in these positions. During the combustion, these positions release different matters containing the alkali metal element and/or the alkaline earth metal element to different spaces of the combustion chamber, so as to adjust combustion state inside the combustion chamber and thereby realize the control of the combustion process. Additionally, the matter containing the alkali metal element and/or the alkaline earth metal element in the depression or the hole acts as a storage of the alkali metal element and/or the alkaline earth metal element during the combustion to prevent the deficiency or content fluctuation of the alkali metal element and/or the alkaline earth metal element during the combustion, thereby controlling the combustion. The component includes one or more selected from the group consisting of a combustion chamber, a piston, a connecting rod of a piston, a cylinder sleeve, a nozzle, a spark plug, a rotor, a blade, a bearing, a bearing seat, a bolt, and a nut inside the combustion chamber.

In some embodiments, an orifice of the through-hole, an opening of the depression, or a base of the protrusion has a maximum cross-sectional area of 0.01 nm² to 1 m²; a depth of the depression or a height of the protrusion is in a range of 0.1 nm to 100 mm; and the depression or the protrusion is of any geometry shape. In some embodiments, the component includes one or more selected from the group consisting of the combustion chamber and a component inside the combustion chamber.

In some embodiments, according to this disclosure, the component or a part of the component of the combustion equipment is made of a material containing the alkali metal element and/or the alkaline earth metal element; a content of the alkali metal element and/or the alkaline earth metal element in the material containing the alkali metal element and/or the alkaline earth metal element is in a range of 0 wt %-99.990000000000 wt %, but excluding 0 wt %; the material containing the alkali metal element and/or the alkaline earth metal element includes a polymer, a metal, and a ceramic; and the combustion equipment includes any kind of combustion equipment. The combustion equipment can promote the combustion of the combustible, has higher power output and a longer usage life, as well as higher mechanical reliability.

According to the above control theory of the combustion, this disclosure provides a piston engine. The piston engine is characterized by a depression configured on an inner surface of a cylinder, or a depression and/or a protrusion configured on an outer surface of the cylinder; the depression or the protrusion is of any geometry shape; there is or is not a protrusion in the depression; and the depression or the protrusion is arranged regularly or irregularly.

In some embodiments, an opening of the depression or a base of the protrusion has a surface area of 0.01 nm² to 0.03 m²; and a depth of the depression or a height of the protrusion is in a range of 0.1 nm to 100 mm.

In some embodiments, there is a groove and/or a blind hole on the inner surface and/or the outer surface of the cylinder; a width of the groove or a diameter of the blind hole is in a range of 0.001 μm to 10 mm; and a depth of the groove or the blind hole is in a range of 0.001 μm to 10 mm.

In some embodiments, a component or a part of the component of the piston engine is made of a material containing the alkali metal element and/or the alkaline earth metal element; a content of the alkali metal element and/or the alkaline earth metal element in the material containing the alkali metal element and/or the alkaline earth metal element is in a range of 0 wt %-99.990000000000 wt %, but excluding 0 wt %; and the material containing the alkali metal element and/or the alkaline earth metal element includes one selected from the group consisting of a polymer, a metal, and a ceramic. In some embodiments, the component includes one or more selected from the group consisting of: a combustion chamber, a piston, a connecting rod of a piston, a cylinder sleeve, a nozzle, a spark plug, a bolt, a nut inside the combustion chamber, a container or a pipeline for a lubricating oil for the combustion chamber, a container or a pipeline for a fuel, and a container or a pipeline for a combustion-supporting material, and a filter.

In some embodiments, the piston engine is also characterized by including or not including a liquid cooling system; a combustible used for the piston engine includes one or more selected from the group consisting of gasoline, diesel, bio-diesel, a plant oil, an animal oil, bio-ethanol, bio-methanol, ethanol, methanol, ammonia, hydrogen, natural gas, acetylene, methane, liquidized petroleum gas, a polymer-based carbon-containing organic matter, and a plant-based carbon-containing organic matter.

Since the combustible contains the alkali metal element and/or the alkaline earth metal element, a carbon-containing material is formed on a surface of a combustion chamber or a component of the combustion chamber of the combustion equipment during the combustion. In some embodiments, a thickness of the carbon-containing material is in a range of 0.1 nm to 1 mm; a surface of the carbon-containing material is of any structure and macroscopic morphology; and the carbon-containing material acts as a buffer storage of the alkali metal element, the alkaline earth metal element, and carbon element, and has one or more functions as follows: lubrication, sealing, thermal conduction, thermal insulation, high and low temperature resistance, wear resistance, thermal shock resistance, corrosion resistance, explosive combustion resistance, or surface defect repair of combustion equipment. Therefore, the combustion equipment or fuel provided by this disclosure can make the combustion equipment have excellent characteristics including lubrication, sealing, thermal conduction, thermal insulation, high and low temperature resistance, wear resistance, thermal shock resistance, corrosive resistance, explosive combustion resistance, thermal fatigue resistance, mechanical fatigue resistance, or surface defect repair of the combustion equipment. Therefore, the combustion equipment can withstand a higher combustion temperature and gas pressure, so as to promote the combustion of the combustible, improve the power output and the service life of the combustion equipment. Thus, there is no need to configure a liquid cooling system or an external forced lubrication system.

In some embodiments, the method of this disclosure can allow more air or other kind of combustion-supporting gas to enter the cylinder, and thus the high-pressure gas intake is adopted to increase the generated gas amount and cylinder pressure during the combustion, thereby further improving the power output of the piston engine.

Specially noted, the piston engine according to this disclosure includes piston engines using all kinds of combustibles, for example, gasoline engine, diesel engine, internal combustion engine, ammonia-mixed fuel-powered engine, hydrogen-mixed fuel-powered engine, or mixed fuel-powered piston engine.

This disclosure also provides a fuel that can enhance the power output and usage life of the combustion equipment. The fuel includes a combustible and an alkali metal element and/or an alkaline earth metal element. In some embodiments, the alkali metal element and/or the alkaline earth metal element is added in an amount of 0 wt %-100000.9999999999999999 wt %, but not being 0 wt %, of a mass of the combustible.

In some embodiments, a mass of the alkali metal element and/or the alkaline earth metal element is 0 wt %-90.9999999999999999 wt %, but not being 0 wt %, of the mass of the combustible.

The fuel provided by this disclosure is applicable to all kinds of combustion equipment, and can prevent explosive combustion and promote the combustion of the combustible and enhance the power output and prolong usage life of the combustion equipment, as well as make the combustion equipment work more safely. An example of the fuel includes anti-explosive combustion fuel, internal combustion engine fuel, external combustion engine fuel, piston engine fuel, mixed fuel-powered engine fuel, mixed fuel, turbofan engine fuel, turbojet engine fuel, gas turbine fuel, boiler fuel, fuel cell fuel, nuclear fusion fuel, nuclear fission fuel, warmer fuel, oven fuel, thermoelectric conversion device fuel, or heat-cold conversion device.

This disclosure also provides a highly-efficient energy conversion system, including a fuel and a combustion equipment, where the fuel is the fuel as described in above technical solutions; and the combustion equipment is the combustion equipment as described in above technical solutions. The highly-efficient energy conversion system can start, work, prevent explosive combustion, output higher power, and have a longer usage life in any environment, as well as greater mechanical reliability.

In order to further improve the combustion efficiency of the combustible, in some embodiments, the highly-efficient energy conversion system further includes other energy conversion equipment connected with the combustion equipment; and the other energy conversion equipment includes at least one selected from the group consisting of refrigeration equipment, hot water boiler, steam boiler, industrial kiln, industrial oven, thermoelectric conversion device, and generator driven by steam boiler.

This disclosure provides a method for promoting combustion of a combustible and enhancing a power output and a usage life of a combustion equipment by adding an alkali metal element and/or an alkaline earth metal element into the combustible. The inventor Professor Dr. Yongheng ZHANG (Professor Dr. Yongheng ZHANG is the lawful representative, president, and manager of Qingdao Hengnengda Energy Technologies Co., Ltd., China, he has PhD, MSc and BSc in material engineering and is a professor in materials science since 2004.) found that the combustion of the combustible must involve the process of plasma formation. The carbon-containing organic matter must be ignited for combustion. For example, a piece of paper is ignited with a match, the natural gas is ignited with an electrical lighter, and the gasoline inside cylinder is ignited with a spark plug. These sparks for igniting include plasma. After igniting the combustible with these sparks, there must be the alkali metal element and/or the alkaline earth metal element making the combustible to be ignited generate more plasma. These plasmas would continue to ignite more combustible, so as to let the combustion process continue until that the combustible completely burns out. If there is no alkali metal element and/or alkaline earth metal element in the combustible or environment, or if the environmental temperature does not reach a certain temperature, the combustion cannot proceed. Similarly, other types of combustibles such as hydrogen, sulfur, phosphorus, or metal also require a plasma to initiate their reaction with oxygen, or their combustion. The formation of plasma must involve the participation of an alkali metal element and/or an alkaline earth metal element. This is to say, the alkali metal element and/or the alkaline earth metal element is essential element for plasma formation.

Based on the combustion principle of the combustible as described above, the alkali metal element and/or the alkaline earth metal element is added into the combustible to initiate the combustion, which promotes the formation of more plasma, thereby promoting the combustion of the combustible. By controlling the amount of the alkali metal element and/or the alkaline earth metal element in the combustible, the combustion process, combustion characteristics (such as color, temperature distribution, combustion rate, airflow speed and direction, and combustion degree during the combustion) can be controlled. More importantly, the technology of the present disclosure is applicable to all types and forms of combustibles and all kinds of combustion equipment.

During the combustion, the alkali metal element and/or the alkaline earth metal element reacts with the surface layer of the combustion equipment, which damages the surface layer of the combustion equipment, accompanying with generating heat. When the surface layer of the combustion equipment cannot be rebuilt, the temperature of the combustion equipment (including the environment of combustion equipment) would rise constantly until the combustion chamber is melted. When the destroying and rebuilding of the surface layer of the combustion equipment reaches an equilibrium, the temperature of the combustion equipment become constant and the combustion equipment is heated. Also, the environmental temperature is raised. During the combustion, the destroying and rebuilding of the surface layer of the combustion equipment are related with contents and compositions of the alkali metal element and/or the alkaline earth metal element, the combustible, the noncombustible, and environmental temperature. When the content of the alkali metal element and/or the alkaline earth metal element in the combustion equipment is higher, it results in greater destroy degree and larger rebuilding rate of the surface layer of the combustion equipment, resulting in more heat generated.

In the present disclosure, the alkali metal element and/or the alkaline earth metal element is added into the combustible, and a carbon-containing material (a carbon-containing layer) is formed on a surface of the combustion equipment during the combustion. According to need, the types and contents of the alkali metal element and/or the alkaline earth metal element added into the combustible can be adjusted to make the carbon-containing material layer have functions of lubrication, sealing, thermal conduction, thermal insulation, high and low temperature resistance, wear resistance, thermal shock resistance, corrosion resistance, explosive combustion resistance, or surface defect repair of the combustion equipment. Therefore, the combustion temperature inside the combustion equipment is higher, the combustion rate is larger and the combustion is more thorough, the combustion equipment is heated at a larger rate, the piston motion proceeds with lower frictional resistance, the impeller and blade exhibit resistance to higher temperature, and the combustion equipment could output higher power output and a longer mechanical usage life, with lower working noise and a smaller volume of the combustion equipment. According to the theory proposed by Professor Dr. Yongheng ZHANG, the power output of the combustion equipment can be increased by multiple times.

Another important technical feature of the method for promoting the combustion of a combustible, and enhancing a power output and a usage life of a combustion equipment lies in more efficiently utilizing the exhaust gas of a primary combustion equipment to heat a secondary combustion equipment. Due to the addition of the alkali metal element and/or the alkaline earth metal element into the combustible, the exhaust gas of the primary combustion equipment contains the alkali metal element and/or the alkaline earth metal element. The alkali metal element and/or the alkaline earth metal element would destroy and rebuild the surface layer of the secondary combustion equipment, which is accompanied with generating heat to heat the secondary combustion equipment. In some embodiments, the secondary combustion equipment includes a boiler, industrial kiln, heating box, or refrigeration device. The boiler as the secondary combustion equipment drives a steam turbine, and the steam turbine drives the generator. Therefore, the energy conversion efficiency of the combustible is further improved.

In conclusion, through the method according to the present disclosure, the combustion of the combustible is promoted, the power output of the combustion equipment is improved, and the usage life of the combustion equipment is prolonged; various carbon-containing organic matters can be fully utilized as a fuel for the combustion equipment; the volume of the combustion equipment is smaller, but the power output thereof is increased; the structure of the combustion equipment is simplified; the combustion efficiency of the combustible is increased; the combustion equipment starts normally and works efficiently in any environment; and the reliability of the combustion equipment is improved.

### Technical Advantageous

The advantages of embodiments of the present disclosure over prior art include but are not limited to the followings:

(1) The method provided by this disclosure can promote the combustion of all types of combustibles, such as carbon, resin, polyethylene plastic, gasoline, diesel, bio-diesel, bio-ethanol, bio-methanol, a plant oil, an animal oil, natural gas, liquefied petroleum gas, coal-to-gas, ethanol, methanol, toluene, methane, acetylene, ethane, ammonia, hydrogen, deuterium, tritium, sulfur, phosphorus, a metal or a mixture of the aforementioned. The method according to the present disclosure is applicable to all kinds of combustion equipment, such as gasoline engine, diesel engine, internal combustion engine, piston engine, turbojet engine, turbofan engine, rocket engine, nuclear fusion reactor, nuclear fission reactor, fuel cell, gas turbine, boiler, and a thermoelectric conversion device. But the existing technologies are only applicable to limited several kinds of fuels and combustion equipment.

(2) In this disclosure, adding the alkali metal element and/or the alkaline earth metal element into the combustible can not only improve the combustion efficiency of the combustible, but also control the combustion process by adjusting the combustion efficiency, combustion rate, and combustion characteristics of the combustible. Through controlling the combustion process, the noise and vibration during the combustion can be controlled. However, the existing technologies cannot achieve the control of the above combustion process of the combustible.

(3) In this disclosure, adding the alkali metal element and/or the alkaline earth metal element into the combustible results in the formation of a carbon-containing layer on a surface of the combustion equipment, which has various functions (such as lubrication, wear resistance, thermal conduction, thermal insulation, corrosion resistance, high and low temperature resistance, thermal shock resistance), thereby reducing noise during the combustion, increase the combustion temperature, enhance the output power and the usage life of the combustion equipment. Moreover, for gasoline engines, diesel engines, and piston engines, a liquid cooling system of the engine can be omitted, thereby simplifying the mechanical structure of the engine. The existing technologies could not form a carbon-containing layer with various functions on the surface of the combustion equipment, fail to significantly enhance the power output of the combustion equipment, cannot extend the service life of the combustion equipment, and are unable to simplify the engine structure.

(4) In this disclosure, adding the alkali metal element and/or the alkaline earth metal element into the combustible results in the increase of thermal efficiency and combustion rate of the combustible, thereby reducing the volume of the combustion equipment. For example, a power output of 1-liter gasoline engine or diesel engine is equivalent to an existing 2.5-liter gasoline engine or diesel engine, while a 50-centimeter diameter jet engine or rocket engine generates a thrust equivalent to an existing 1-meter diameter engine. As a result, the fuel consumption is greatly reduced and the mechanical life is extended. The existing technology cannot achieve such significant technical progress of the combustion equipment.

(5) In this disclosure, adding the alkali metal element and/or the alkaline earth metal element into the combustible can reduce the noise and vibration of the combustion equipment during the combustion, while the existing technology cannot control the noise and vibration during the combustion.

(6) In this disclosure, adding the alkali metal element and/or the alkaline earth metal element into the combustible can greatly increase the combustion rate and combustion temperature of the combustible, thereby increasing the temperature rising rate of the combustion equipment and meanwhile saving a large amount of fuel, with a fuel saved generally by 20%-40% (compared with existing gasoline engines). The existing technologies can only have a small combustion promoting effect on one type of fuel, with a fuel saved generally by 10% or lower.

(7) In this disclosure, adding the alkali metal element and/or the alkaline earth metal element into the combustible can make the combustible to be ignited easily at high altitude area, high air area, or universal space, and increase the combustion efficiency of the combustible, and greatly increase the power output of the combustion equipment and save the fuel. But the existing technology cannot achieve this technical goal.

(8) In this disclosure, adding the alkali metal element and/or the alkaline earth metal element into the combustible can make the combustion equipment start normally and work efficiently in any environment. For example, all kinds of combustion equipment start normally and work efficiently at a temperature from −250° C. to 2500° C. The existing technology cannot achieve this technical goal.

(9) In this disclosure, adding the alkali metal element and/or the alkaline earth metal element into the combustible can improve the combustion efficiency and thermal efficiency of renewable fuels such as bio-diesel, bio-ethanol, bio-methanol, a plant oil, an animal oil, a plant-derived fuel, making them suitable for various combustion equipment such as piston engines, gas turbines, jet engines, or rocket engines. But the existing technology cannot achieve this technical goal.

(10) The additive to promote the combustion of the combustible according to the present disclosure is non-toxic, harmless, cost-effective, and recyclable.

(11) The effect of exhaust gas from the combustion equipment in prior art used to heat other heating equipment is poor, and the exhaust gas from the heating equipment cannot be utilized or well utilized. In this disclosure, by adding the alkali metal element and/or the alkaline earth metal element into the combustible, it enables the exhaust gas from the primary combustion equipment to generate more heat when heating the secondary combustion equipment, thereby further improving the combustion efficiency and energy conversion efficiency of the fuel. These secondary heating devices can also drive various energy conversion equipment such as steam turbines, and steam turbines can drive generators. But the existing technology cannot achieve this technical goal.

(12) The technology disclosed in this disclosure can enable a mixed fuel to be used for various combustion equipment. The mixed fuel includes several of diesel, gasoline, bio-diesel, bio-ethanol, bio-methanol, ethanol, methanol, ammonia, an animal oil, and a plant oil, a polymer-derived carbon-containing organic matter, or a plant-derived carbon-containing organic matter. Therefore, various kinds of fuels are fully utilized and their combustion efficiency is improved. But the existing technology cannot achieve this technical goal.

(13) The fuel provided by this disclosure can initiate nuclear fusion reaction or nuclear fission reaction, and keep the nuclear fusion or nuclear fission proceed and be controllable, so the nuclear fusion or nuclear fission can be utilized and commercialized. But the existing technology cannot achieve this technical goal.

(14) This disclosure provides the nuclear fusion reactor or nuclear fission reactor to realize nuclear fusion reaction or nuclear fission reaction. But the existing technology cannot achieve this technical goal.

(15) The fuel and engine according to the present disclosure enable ammonia-mixed fuel-powered engine and hydrogen-mixed fuel-powered engine start and work normally. But the existing technology cannot achieve this goal.

(16) This disclosure can make fuel cell have higher efficiency. But the existing technology cannot achieve this technical goal.

(17) The combustion equipment according to the present disclosure, for example piston engine, could be configured without a liquid cooling system or a forced lubrication system. But the existing technology cannot achieve this technical goal.

(18) The fuel and the combustion equipment for prevent explosive combustion according to the present disclosure make combustion process safer. But the existing technology cannot achieve this technical goal.

(19) This disclosure can greatly enhance the mechanical reliability of the combustion equipment, so as to prolong its usage life. But the existing technology cannot achieve this technical goal.

### Industrial Applications

Industrial applications of this disclosure include but not limited to the followings.
a fuel that enables the combustion equipment to have higher power output and longer usage life;
a combustion equipment having a higher combustion efficiency, a higher power output, and a longer service life;
enabling various fuels to prevent explosive combustion;
making a combustion process safer and reliable;
enabling a mixed fuel to be used for a combustion equipment;
a combustion equipment with a more compact structure, higher power, and longer usage life, with a greater safety in use;
allowing for a better control of the combustion process;
enabling all the combustion equipment to be ignited, start and work in any environment;
a combustion chamber of the combustion equipment to be configured without a liquid cooling system or a forced lubrication system;
reduced toxic emission during the combustion; and
realizing nuclear fusion reaction and nuclear fission reaction and making them controllable.

### DETAILED DESCRIPTION OF THE EMBODIMENTS

The present disclosure provides a method for promoting combustion of a combustible and enhancing power output and usage life of a combustion equipment. An alkali metal element and/or an alkaline earth metal element is added into the combustible; a matter state of the combustible includes at least one of gas, liquid, and solid. The alkali metal element includes one or more of Li, Na, K, Rb, Cs, and Fr, and the alkaline earth metal element includes one or more of Be, Mg, Ca, Sr, Ba, and Ra.

Different from prior technology, this disclosure is applicable to all combustibles, for example, one or more of carbon, a carbon-containing organic matter, carbon dioxide, ammonia, hydrogen, sulfur, phosphorus, and a metal. In some embodiments, the carbon includes carbon powder. In some embodiments, the carbon-containing organic matter includes all carbon-containing organic matters, such as one or more of resin, polyethylene plastic, gasoline, diesel, bio-diesel, a vegetable oil, an animal oil, bio-ethanol, bio-methanol, natural gas, aviation kerosene, liquefied petroleum gas, coal-to-gas, ethanol, methanol, toluene, acetylene, methane, ethane, a polymer-based carbon-containing organic matter, and a plant-based carbon-containing organic matter.

In this disclosure, the alkali metal element and/or the alkaline earth metal element may be in any form, preferably one or more of atom, ion, and plasma.

In some embodiments, the alkali metal element and/or the alkaline earth metal element is added in a form of a matter containing the alkali metal element and/or the alkaline earth metal element. In some embodiments, the matter containing the alkali metal element and/or the alkaline earth metal element include one or more of a plasma, an elementary substance, an alloy, a compound, and a composition containing the alkali metal element and/or the alkaline earth metal element; preferably, it is added in a form including one or more of a plasma, an elementary substance, an alloy, a compound, and a composition. The matter containing the alkali metal element and/or the alkaline earth metal element can be at any state, preferably including plasma, gas, liquid, or solid. The compound or the composition includes one or more of all organic compounds or inorganic compounds.

In some embodiments, under a condition that the alkali metal element is added in a form of an elementary substance, the elementary substance is at least one of Li, Na, K, Rb, Cs, and Fr. Under a condition that the alkali metal element is added in a form of an alloy, the alloy may be any type of alloys containing the alkali metal element, for example lithium aluminum alloy, calcium lithium silicon alloy, lithium calcium alloy, calcium magnesium lithium alloy, iron nickel magnesium lithium carbon alloy, titanium lithium alloy, and titanium magnesium lithium alloy. Under the condition that the alkali metal element is added in a form of a compound, the compound includes one or more of all compounds of the alkali metal element, including organic compounds, or inorganic compounds, specifically for example, organic acid salts, inorganic acid salts, oxides, bases, further specifically for example one or more of alkoxide, phenoxide, acetate, oxalate, citrate, hydrochloride, sulfate, carbonate, aluminosilicate, phosphate, and hydroxide. It should be noted that the alkali metal element(s) in these compounds is necessary elements for generating plasma. Other ions or components that make up these compounds can only affect the temperature required to generate plasma. In the present disclosure, compound(s) selected to be added is determined by the type of combustion equipment and the type of the combustible. For example, the piston engine allows a lower combustion temperature, the compounds that are easily decomposed and has a higher degree of ionization, such as acetate, oxalate, citrate, or chloride are added. For the combustion equipment that allows a higher combustion temperature, such as gas turbines, jet engines, and rocket engines, a proper quantity of compounds with higher thermal decomposition temperatures and lower degrees of ionization, such as phosphates, aluminosilicates, and hydroxides, needs to be added to ensure a sustained supply of the alkali metal element and/or the alkaline earth metal element inside the combustion chamber.

In some embodiments, the compound containing the alkali metal element is at least one of sodium hydroxide, potassium hydroxide, lithium acetate, potassium acetate, and sodium acetate. Under a condition that the alkali metal element is added in a form of a mixture, the mixture is a mixture of lithium acetate and potassium acetate, or a mixture of potassium acetate and potassium hydroxide, or a mixture of sodium acetate and sodium hydroxide, or a mixture of potassium acetate and sodium hydroxide, or a mixture of potassium acetate, sodium acetate, and lithium acetate. The alkali metal element may also be added to the combustible after being mixed with alkaline earth metal element(s), for example magnesium chloride and potassium hydroxide, or magnesium chloride and sodium hydroxide, or magnesium chloride and potassium acetate, or magnesium chloride and sodium acetate, or calcium chloride and potassium acetate and lithium acetate and sodium acetate.

In some embodiments, under a condition that the alkaline earth metal element is added in a form of an elementary substance, the elementary substance preferably is at least one of Be, Mg, Ca, Sr, Ba, and Ra. Under a condition that the alkaline earth metal element is added in a form of an alloy, the alloy may be any type of alloys containing the alkaline earth metal element, for example, at least one of magnesium aluminum alloy, calcium silicon alloy, lithium calcium alloy, calcium magnesium lithium alloy, iron calcium magnesium carbon, iron nickel calcium carbon alloy, and titanium magnesium lithium alloy. Under a condition that the alkaline earth metal element is added in a form of a compound, the compound includes one or more of all alkaline earth metal compounds, including organic compounds, inorganic compounds or oxides, specifically for example organic acid salts, inorganic acid salts, or bases, further specifically for example one or more of alkoxide, phenoxide, acetate, oxalate, citrate, hydrochloride, sulfate, carbonate, aluminosilicate, phosphate, and hydroxide. It should be noted that the alkaline earth metal element in these compounds are necessary elements for generating plasma. Other ions or components that make up these compounds can only affect the temperature required to generate plasma. Compounds selected to be added is determined by the type of combustion equipment and the type of combustibles. The alkaline metal element is added in the same principle as mentioned above. In some embodiments, the alkaline earth metal element is added in a form of organic acid salts, inorganic acid salts, or bases of the alkaline earth metal element, specifically for example, acetate or hydrochloride. In some embodiments, the compound containing the alkaline earth metal element is at least one of magnesium chloride, magnesium acetate, and calcium chloride. Under the condition that the alkaline earth metal element is added in a form of a mixture, an example of the mixture is magnesium chloride and magnesium acetate. The alkali metal element and the alkaline earth metal element may be simultaneously added into the combustible, for example, magnesium chloride and potassium acetate, magnesium chloride and potassium hydroxide, calcium chloride and potassium acetate and lithium acetate and sodium acetate is added into the combustible. The specific addition proportion depends on the combustion equipment and combustible. It should be emphasized that the alkali metal element and the alkaline earth metal element may also be added in a form of an alloy containing the alkali metal element and the alkaline earth metal element, such as aluminum magnesium lithium alloy, aluminum calcium lithium alloy, iron magnesium carbon alloy, iron nickel calcium magnesium carbon alloy, titanium lithium alloy, or titanium magnesium lithium alloy. These alloys are particularly suitable for being used to manufacture a combustion chamber of the combustion equipment, and a component thereof, such as cylinder sleeve, piston, rotor and blade.

In some embodiments, the alkali metal element and/or the alkaline earth metal element is added in an amount of 0 wt % to 10000.9999999999999999 wt %, not being 0 wt %, of a mass of the combustible. In some embodiments, the alkali metal element and/or the alkaline earth metal element is added in an amount of 0 wt % to 90.9999999999999999 wt %. In this disclosure, the alkali metal element and/or the alkaline earth metal element reacts with carbon element to generate a new carbon-containing material, or a plasma, thereby igniting the combustion and keep the combustion process be continued. Meantime, the alkali metal element and/or the alkaline earth metal element destroys and also rebuilds a carbon-containing layer on a surface of the combustion equipment, which is accompanied heat generation to heat the combustion equipment, thereby further promoting the plasma formation. This is to say, the formation of plasma and heating the combustion equipment is promoted by each other until the destroying and rebuilding of the carbon-containing layer reaches an equilibrium, then the temperature of the combustion equipment also reaches an equilibrium.

In this disclosure, the combustion equipment includes all kinds of combustion equipment. The combustion equipment may start and work efficiently in any environment and output higher power and has a longer usage life, as well as higher mechanical reliability.

In some embodiments, the combustion equipment includes one or more of a primary combustion equipment and a secondary combustion equipment that utilizes an exhaust gas of the primary combustion equipment. In some embodiments, the primary combustion equipment includes one or more of gasoline engine, diesel engine, internal combustion engine, ammonia-mixed fuel-powered engine, hydrogen-mixed fuel-powered engine, mixed fuel-powered piston engine, piston engine, turbofan engine, turbojet engine, rocket engine, mixed fuel gas turbine, gas turbine, boiler, nuclear fusion reactor, nuclear fission reactor, fuel cell, warmer, oven, thermoelectric conversion device, and heat-cold conversion device. The secondary combustion equipment that utilizes an exhaust gas of a primary combustion equipment includes boiler, industrial kiln, refrigeration device, thermoelectric conversion device, and heat-cold conversion device. The boiler includes steam boiler, or hot water boiler.

In this disclosure, the addition of the alkali metal element and/or the alkaline earth metal element can make the surface layer of combustion equipment be destroyed and rebuilt constantly to generate heat, so as to heat the combustion equipment. Particularly importantly, the exhaust gas of the primary combustion equipment contains a high concentration of the alkali metal element and/or the alkaline earth metal element and a low concentration of carbon-containing organic matter. This kind of exhaust gas can easily destroy the carbon-containing layer of the secondary combustion equipment to produce plasma, so as to heat the combustion equipment. Therefore, the thermal efficiency or energy conversion efficiency of fuel is further improved.

In this disclosure, the combustible containing the alkali metal element and/or the alkaline earth metal element generates a carbon-containing material during the combustion, and the carbon-containing material contains the alkali metal element and/or the alkaline earth metal element, and has a thickness from 0.1 nm to 1 mm. The carbon-containing material has at least one of functions as follows: lubrication, wear resistance, sealing, thermal conduction, thermal insulation, high and low temperature resistance, thermal shock resistance, corrosive resistance, explosive combustion resistance, and surface defect repair of combustion equipment. Therefore, the combustion equipment may be not equipped with a liquid cooling system, or not equipped with an external forced lubrication system.

Particularly importantly, the alkali metal element and/or the alkaline earth metal element may be added to deuterium and tritium to initiate hydrogen nuclear fusion and keep the nuclear fusion process be continued and be under control. The hydrogen nuclear fusion is initiated by plasma and requires more alkali metal element and/or alkaline earth metal element during the nuclear fusion.

In some embodiments, the alkali metal element and/or the alkaline earth metal element is added in an amount of 0.000000000000001 wt %-1000 wt % of a mass of deuterium and tritium. Similarly, the nuclear fusion of metal requires the alkali metal element and/or the alkaline earth metal element to make the metal become a plasma, so as to realize the reaction among nucleus. In some embodiments, a content of the alkali metal element and/or the alkaline earth metal element in a fuel for nuclear fusion is in a range of 0.0001 wt %-100 wt %. Based on the same principle, the nuclear fission of non-radioactive metal requires the alkali metal element and/or the alkaline earth metal element to make the metal become a super high-temperature plasma, so as to realize the fission of metal nucleus and the formation of a new metal and a new metal-carbon-containing material composite. The inventor needs to particularly indicate that the nuclear fusion or nuclear fission must require the participation of the carbon-containing organic matter to make fusion material or fission material become into a plasma. Only by using the fuel and combustion equipment according to the method of the present disclosure, the superhigh temperature plasma can be produced, so as to realize the nuclear fusion reaction or nuclear fission reaction, as well as the controllability of nuclear fusion reaction process or nuclear fission reaction process.

In some embodiments, the carbon-containing organic matter and the alkali metal element and/or the alkaline earth metal element are added to hydrogen or ammonia to serve as a fuel. In some embodiments, the alkali metal element and/or the alkaline earth metal element is added in an amount of 0.0001 wt %-10000 wt % of a mass of ammonia or hydrogen. In this disclosure, the alkali metal element and/or the alkaline earth metal element is added to the combustible by an approach including at least one of approach I, approach II, approach III and approach IV.

In some embodiments, the approach to add the alkali metal element and/or the alkaline earth metal element to the combustible includes approach I. The approach I includes subjecting a matter containing the alkali metal element and/or the alkaline earth metal element to stirring, ball milling, pulverizing, melting, electrical sparking or plasmizating, and then adding a resulting material to the combustible; or mixing a matter containing the alkali metal element and/or the alkaline earth metal element with a noncombustible, and then adding a resulting mixture to the combustible. The matter containing the alkali metal element and/or the alkaline earth metal element includes one or more of an elementary substance, an alloy, a compound, and a composition, which will not be repeated later. In some embodiments, the stirring is conducted at a temperature of 0-500° C., or at a temperature of lower than −100° C. For example, cryogenic liquid, such as liquid oxygen, liquid hydrogen, liquefied natural gas, and liquid methane, needs to be mixed at low temperature, generally below −100° C. The approach I is applicable to the combustible of any matter state. The noncombustible includes one or more of all kinds of noncombustibles. An example of the noncombustible is H₂O, N₂, O₂, NO, CO₂, Fe₂O₃, or SiO₂.

In some embodiments, the approach to add the alkali metal element and/or the alkaline earth metal element into the combustible includes approach II. The approach II includes dissolving the matter containing the alkali metal element and/or the alkaline earth metal element into the combustible. The approach II is applicable to all nongaseous combustibles.

In some embodiments, the approach to add the alkali metal element and/or the alkaline earth metal element to the combustible includes approach III. The approach III includes mixing the matter containing the alkali metal element and/or the alkaline earth metal element with a solvent to obtain a solution, a suspension, or a paste, and then adding the solution, the suspension, the paste to the combustible. The solvent includes at least one of inorganic solvents and organic solvents. An example of the inorganic solvents is water and an organic acid solution. An example of the organic solvents is at least one of formic acid, an alcohol, an aromatic hydrocarbon, an aliphatic hydrocarbon, an alicyclic hydrocarbon, and a halogenated hydrocarbon. In a specific embodiment of the present disclosure, the organic solvent is ethanol.

In some embodiments, the approach to add the alkali metal element and/or the alkaline earth metal element into the combustible includes approach IV. The approach IV includes: manufacturing a combustion chamber of the combustion equipment, a component of the combustion chamber, a container for a lubricating oil, a container for a fuel, or a container for a combustion-supporting material, a filter, or a delivery pipeline by using a material containing the alkali metal element and/or the alkaline earth metal element. This kind of combustion equipment can start and work efficiently in any environment and output a higher power and has longer usage life, as well as higher mechanical reliability.

In some embodiments, the material containing the alkali metal element and/or the alkaline earth metal element includes one or more of a polymer, a ceramic, or a metal. In some embodiments, the polymer includes rubber. In some embodiments, the metal includes an elementary substance of the metal and/or an alloy. When the combustible or the combustion-supporting material contacts with these materials, the combustible or the combustion-supporting material reacts with the alkali metal, the alkaline earth metal, an alkali metal compound, an alkaline earth metal compound, a metal, or an alloy, to generate a compound containing the alkali metal element and/or the alkaline earth metal element, which thereby is mixed with the combustible and/or the combustion-supporting material. The combustion equipment and a component thereof include a combustion chamber, a cylinder sleeve, a nozzle, a spark plug, a piston, a connecting rod, a rotor, or a blade. In some embodiments, a content of the alkali metal element and/or the alkaline earth metal element in the material containing the alkali metal element and/or the alkaline earth metal element is in a range of 0.0000000001 wt %-99.99 wt %. In some embodiments, a content of the alkali metal element and/or the alkaline earth metal element in the alloy is in a range of 0.00000000001 wt %-99.99 wt %.

In some embodiments, a depression, a protrusion, or a hole is configured in the component of the combustion equipment, such that matters containing the alkali metal element and/or the alkaline earth metal element with different chemical compositions and structures are generated in these positions. During the combustion, these positions release different matters containing the alkali metal element and/or the alkaline earth metal element to different spaces of the combustion chamber to prevent the deficiency or content fluctuation of the alkali metal element and/or the alkaline earth metal element during the combustion, so as to adjust the combustion state in the combustion chamber, thereby realizing the control of the combustion.

In some embodiments, an orifice of a through-hole, an opening of the depression, or a base of the protrusion has a maximum cross-sectional area of 0.01 nm² to 1 m². In some embodiments, a depth of the depression or a height of the protrusion is in a range of 0.1 nm to 100 mm. In some embodiments, the depression or the protrusion is of any geometry shape. The part includes one or more of a combustion chamber or a component of the combustion chamber.

In some embodiments, a component or a part of a component of the combustion equipment is made of a material containing the alkali metal element and/or the alkaline earth metal element. In some embodiments, a content of the alkali metal element and/or the alkaline earth metal element in the material containing the alkali metal element and/or the alkaline earth metal element is in a range of 0 wt %-99.990000000000 wt %, excluding 0 wt %. In some embodiments, the material containing the alkali metal element and/or the alkaline earth metal element includes a polymer, a metal, or a ceramic. In some embodiments, the combustion equipment includes any kind of combustion equipment. Such kind of combustion equipment can promote the combustion of the combustible, and output higher power and has a longer usage life, as well as higher mechanical reliability.

This disclosure also provides a piston engine. The piston engine includes a liquid cooling system or does not include a liquid cooling system. A fuel used for the piston engine is the fuel as described in above technical solutions. The combustible of the fuel includes one or more of gasoline, diesel, bio-diesel, a plant oil, an animal oil, bio-ethanol, bio-methane, a plant oil, an animal oil, ethanol, methanol, hydrogen, ammonia, natural gas, acetylene, methane or liquefied petroleum gas, polymer-based carbon-containing organic matter, and plant-based carbon-containing organic matter.

In some embodiments, a depression is provided on an inner surface of a cylinder of a piston engine, or a depression or a protrusion is provided on an outer surface of a cylinder of a piston engine. In some embodiments, the depression or the protrusion is of any geometry shape. In some embodiments, there is a protrusion or is not a protrusion in the depression. In some embodiments, the depression or the protrusion is arranged regularly or irregularly. In some embodiments, an opening of the depression or a base of the protrusion has a surface area of 0.01 nm² to 0.03 m². In some embodiments, a depth of the depression or a height of the protrusion is in a range of 0.1 nm to 100 mm. In some embodiments, there is a groove and/or a blind hole on the inner surface of the cylinder. In some embodiments, there is a groove, and/or a blind hole, or a protrusion on the outer surface of the cylinder. In some embodiments, a width of the groove or the protrusion, or a diameter of the blind hole is in a range of 0.1 nm to 100 mm. In some embodiments, a depth of the groove or the blind hole is in a range of 0.1 nm to 50 mm. In some embodiments, the protrusion has a height of 0.1 nm to 100 mm, preferably 1 nm to 20 mm. In some embodiments, the groove or the protrusion is of any geometry shape. In some embodiments, the groove or the protrusion or the blind hole is arranged in a regular or irregular arrangement pattern. In some embodiments, the groove or the blind hole is prefilled with a carbon-containing material containing the alkali metal element and/or the alkaline earth metal element; or the groove and/or the blind hole is filled with a carbon-containing material containing the alkali metal element and/or the alkaline earth metal element during the operation of the piston engine. The carbon-containing material containing the alkali metal element and/or the alkaline earth metal element in the groove or the blind hole acts as a storage of the alkali metal element, the alkaline earth metal element and carbon element, and improve at least one of functions as follows: improved sealing of the cylinder, thermal conduction, lubrication, wear resistance, explosive combustion resistance, high and low temperature resistance, and thermal shock resistance.

In some embodiments, the piston engine according to this disclosure can be configured without a liquid cooling system or without an external forced lubrication system. Therefore, the structure of the piston engine is further simplified to enhance its reliability.

In some embodiments, the method according to the present disclosure allows the cylinder of the piston engine to let more air or other kinds of gas in, and thus the high-pressure gas intake is adopted to increase the generated gas amount and cylinder pressure during the combustion, thereby further improving the power output of the piston engine.

In some embodiments of this disclosure, the piston engine is provided with a spark plug ignition system or is provided without a spark plug ignition system. In some embodiments, the combustible in the fuel used for the piston engine includes one or more of gasoline, diesel, bio-diesel, a plant oil, an animal oil, bio-ethanol, bio-methanol, ethanol, methane, ammonia, hydrogen, natural gas, acetylene, methane, liquefied petroleum gas, a polymer-based carbon-containing organic matter, and a plant-based carbon-containing organic matter.

This disclosure also provides a fuel that improves power output and usage life of a combustion equipment, including: a combustible, and an alkali metal element and/or an alkaline earth metal element. In some embodiments, a content of the alkali metal element and/or the alkaline earth metal element is 0 wt %-10000.9999999999999999 wt %, but not being 0 wt %, of a mass of the combustible. In some embodiments, the content of the alkali metal element and/or the alkaline earth metal element is 0 wt %-90.9999999999999999 wt %, but not being 0 wt % of the mass of the combustible. The approach to add the alkali metal element and/or the alkaline earth metal element is the same as descried above, which will not repeated herein.

This disclosure also provides a high-efficiency fuel energy conversion system, including: a combustion equipment and a fuel. The fuel is the fuel as described in above technical solutions. The combustion equipment may be any combustion equipment, particularly the combustion equipment as described in above technical solutions, preferably including one or more of a primary combustion equipment and a secondary combustion equipment. The kinds of the first combustion equipment and the secondary combustion equipment are not repeated herein. In some embodiments, the combustion equipment may be thermoelectric conversion device, nuclear fusion reactor, nuclear fission reactor, engine, or a heating equipment heated by exhaust gas of engine. In some embodiments, the heating equipment heated by exhaust gas of engine includes boiler, industrial kiln, air heater, oven, or refrigeration device. In some embodiments, the boiler includes a steam boiler or a hot water boiler. In some embodiments, an equipment powered by engine includes electrical generator, vehicle, ship, or train. A steam boiler drives a steam turbine, and the steam turbine drives an electrical generator. The heating equipment utilizes the alkali metal element and/or the alkaline earth metal element to destroy and rebuild the surface layer of the heating equipment and while to generate heat, so as to heat up.

In some embodiments, the high-efficiency fuel energy conversion system includes other energy conversion equipment connected with a combustion equipment. In some embodiments, the other energy conversion equipment includes a refrigeration equipment, a hot-water boiler, a steam boiler, an industrial kiln, an industrial oven, a thermoelectric conversion device, and an electrical generator powered by a steam boiler.

The high-efficiency fuel energy conversion system can start and work efficiently, prohibit explosive combustion, output a higher power, and have a longer usage life and higher mechanical reliability.

The following will give a clear and complete description of the technical solution in conjunction with examples. Obviously, these examples are only a portion of examples of the present disclosure. Based on the examples of this disclosure, all other examples obtained by ordinary technicians in the art without creative labor fall within the scope of this disclosure.

### Example 1

2 g of lithium acetate dihydrate was added to 500 mL of anhydrous ethanol, followed by stirring until that the lithium acetate dihydrate was dissolved completely to form a solution of lithium acetate in ethanol. 100 mL of the solution of lithium acetate in ethanol were measured and injected into a car fuel tank. 25 L of 92-octane gasoline were then injected into the car fuel tank. By test, it was found that the fuel consumption per 100 km decreased from 12 L to 10 L. Due to the generation of more plasma during the combustion, the combustion was more rapid. During the combustion, a carbon-containing material layer with good lubrication and sealing effects was generated on the surface of the cylinder, which increased engine power output, reduced fuel consumption by 17%, and reduced engine noise. (Test conditions: The car's engine was 2.5-liter naturally aspirated, with a driving distance of about 133000 km, manufactured in 2010. The car was driven on urban road six times a day, with an average driving distance of about 5 km per time and an average speed of about 25 km per hour).

### Example 2

5 g of magnesium chloride hexahydrate were dissolved in 500 mL of ethanol to obtain a solution of magnesium chloride in ethanol. 100 mL of the solution of magnesium chloride in ethanol were measured and injected into a car fuel tank. 25 L of 92-octane gasoline was then injected into the car fuel tank. By test, it was found that the fuel consumption per 100 km decreased from 12 L to 10 L, saving 20% of gasoline. The test conditions were the same as those in Example 1.

### Example 3

5 g of potassium acetate were dissolved in 500 mL of ethanol to obtain a solution of potassium acetate in ethanol. 100 mL of the solution of potassium acetate in ethanol were injected into a car fuel tank, followed by adding 25 L of 92-octane gasoline into the car fuel tank. By test, it was found that the fuel consumption per 100 km decreased from 12 L to 9.3 L, and the fuel consumption decreased by 22.5%. Test conditions were the same as those in Example 1.

### Example 4

(1) 2 g of sodium hydroxide was dissolved in 500 mL of ethanol to prepare a solution.

(2) 5 g of potassium hydroxide was dissolved in 500 mL of ethanol to prepare a solution.

(3) 5 g of anhydrous potassium acetate was dissolved in 500 mL of ethanol to prepare a solution.

(4) 2 g of anhydrous sodium acetate was dissolved in 500 mL of ethanol to prepare a solution.

(5) 5 g of magnesium chloride hexahydrate was dissolved in 500 mL of ethanol to prepare a solution.

(6) 2 g of lithium acetate dihydrate was dissolved in 500 mL of ethanol to prepare a solution.

(7) 2 g of magnesium acetate tetrahydrate was dissolved in 500 mL of ethanol to prepare a solution.

A certain amount of the above solutions was separately added into 10 L of gasoline, as shown in Table 1. As described in Example 1, the car was driven on the urban elevated road at an average speed of 58 km per hour until 10 L of gasoline are depleted. The driving distance, fuel consumption, and fuel efficiency of the car are shown in Table 1. When alkali metal element and/or alkaline earth element is not added into gasoline, the fuel consumption of the car is 11.5 L per 100 km (30 km/h), 8.5 L per 100 km (58 km/h), and 8.3 L per 100 km (90 km/h), respectively. During driving test, the cooling fan of the coolant did not rotate. It should be noted that in this example, the gasoline cannot be used up every driving test. There were still about 3 L of gasoline left in the fuel tank. Therefore, it was inevitable that there was a mixture of remaining gasoline and newly added gasoline in each test. The results were that the contents of various compounds in the fuel tank were not exactly the contents listed in the Table 1. This result also indicates that the combustion promotion technology of present disclosure has strong practicality.

TABLE 1
Driving distance, fuel consumption, percentage of fuel saved
after adding different solutions into the car fuel

| | | | | | Percen- |
|---|---|---|---|---|---|
| | | | | | tage |
| | | | | | of fuel |
| | | | | | saved |
| | | | Average | | (Fuel |
| | | | fuel | | saved/ |
| | Compound | | con- | | original |
| | added and | | sump- | Fuel | fuel |
| | quantity | | tion | saved | con- |
| | thereof/ | | (liter/ | (liter/ | sump- |
| | 10 L | Driving | 100 | 100 | tion) x |
| No. | gasoline | tdisance | km) | km) | 100% |
| 1 | 80 mL | 165 km, | 6.06 | 2.44 | 29% |
| | KOH | 58 km/h | | | |
| | solution | | | | |
| 2 | 5 mL of | 160 km, | 6.25 | 2.05 | 25% |
| | MgCl₂ | 90 km/h | | | |
| | solution | | | | |
| | and 20 | | | | |
| | mL of | | | | |
| | potassium | | | | |
| | acetate | | | | |
| | solution | | | | |
| 3 | 40 mL of | 173 km, | 5.78 | 2.72 | 32% |
| | potassium | 58 km/h | | | |
| | acetate | | | | |
| | solution | | | | |
| 4 | 25 mL of | 171 km, | 5.84 | 2.66 | 31 |
| | MgC1₂ | 58 km/h | | | |
| | solution | | | | |
| | and 50 | | | | |
| | mL of | | | | |
| | potassium | | | | |
| | acetate | | | | |
| | solution | | | | |
| 5 | 100 mL | 157 km, | 6.37 | 1.93 | 23% |
| | of MgCl₂ | 90 km/h | | | |
| | solution | | | | |
| 6 | 50 mL of | 180 km, | 5.56 | 2.94 | 35% |
| | MgC1₂ | 58 km/h | | | |
| | solution | | | | |
| 7 | 50 mL of | 171 km, | 5.85 | 2.45 | 30% |
| | MgC1₂ | 90 km/h | | | |
| | solution | | | | |
| | and 50 | | | | |
| | mL of | | | | |
| | potassium | | | | |
| | acetate | | | | |
| | solution | | | | |
| 8 | 100 mL of | 120 km, | 8.33 | 3.17 | 28% |
| | potassium | 30 km/h | | | |
| | acetate | | | | |
| | solution | | | | |
| 9 | 100 mL of | 160 km, | 6.25 | 2.05 | 25% |
| | potassium | 90 km/h | | | |
| | acetate | | | | |
| | solution | | | | |
| 10 | 80 mL of | 160 km, | 6.25 | 2.25 | 26% |
| | NaOH | 58 km/h | | | |
| | solution | | | | |
| 11 | 40 mL of | 163 km, | 6.13 | 2.37 | 28% |
| | NaOH | 58 km/h | | | |
| | solution | | | | |
| | and 40 | | | | |
| | mL of | | | | |
| | sodium | | | | |
| | acetate | | | | |
| | solution | | | | |
| 12 | 40 mL of | 178 km, | 5.61 | 2.89 | 34% |
| | NaOH | 58 km/h | | | |
| | solution | | | | |
| | and 80 | | | | |
| | mL of | | | | |
| | sodium | | | | |
| | acetate | | | | |
| | solution | | | | |
| 13 | 40 mL of | 150 km, | 6.67 | 1.83 | 21% |
| | NaOH | 58 km/h | | | |
| | solution | | | | |
| | and 160 | | | | |
| | mL of | | | | |
| | sodium | | | | |
| | acetate | | | | |
| | solution | | | | |
| 14 | 80 mL of | 140 km, | 7.14 | 1.36 | 16% |
| | lithium | 58 km/h | | | |
| | acetate | | | | |
| | solution | | | | |
| 15 | 20 mL of | 150 km, | 6.66 | 1.84 | 22% |
| | lithium | 58 km/h | | | |
| | acetate | | | | |
| | and 20 | | | | |
| | mL of | | | | |
| | sodium | | | | |
| | acetate | | | | |
| | and 25 | | | | |
| | mL of | | | | |
| | potassium | | | | |
| | acetate | | | | |
| | solution | | | | |
| 16 | 25 mL of | 158 km, | 6.33 | 2.17 | 26% |
| | CaC1₂ | 58 km/h | | | |
| | solution | | | | |
| 17 | 80 mL of | 150 km, | 6.66 | 1.84 | 22% |
| | Sodium | 58 km/h | | | |
| | magnesium | | | | |
| | acetate | | | | |
| | solution | | | | |

### Example 5

To verify the application field of the present disclosure in promoting the combustion of combustible materials. One experiment group involved adding 80 mL of sodium acetate solution of Example 5 to the fuel tank, then adding 1 L of ethanol, 1 L of methanol, and 8 L of gasoline to the fuel tank, followed by a driving test. Another one experiment group involved adding 40 mL of potassium acetate solution of Example 5 to the fuel tank, then adding 3 L of ethanol and 7 L of gasoline to the fuel tank, followed by a driving test. Further another one experiment group involved adding 20 mL of potassium acetate solution and 20 mL of sodium acetate solution of Example 5 to the fuel tank, then adding 3 L of methanol and 7 L of gasoline to the fuel tank, followed by a driving test. The driving test results are shown in Table 2. The test results indicate that there is no significant decrease in thermal efficiency of ethanol-gasoline mixture, ethanol-methanol-gasoline mixture, or ethanol-methanol mixture, compared with gasoline fuel alone. The test results demonstrate that the combustion promoting technology of the present disclosure is applicable to a variety of combustible materials.

TABLE 2
Driving test results of mixed fuels of gasoline, ethanol,
and methanol

| | | | | | Percen- |
|---|---|---|---|---|---|
| | | | | | tage |
| | | | | | of fuel |
| | | | Aver- | | saved |
| | | | age | | (fuel |
| | | | fuel | | saved/ |
| | | Dri- | con- | | original |
| | | ving | sump- | Fuel | fuel |
| | | dis- | tion- | saved | con- |
| | | tance | (liter/ | (liter/ | sump- |
| | Fuel | (58 | 100 | 100 | tion) x |
| No. | composition | km/h) | km) | km) | 100% |
| 1 | 1 L ethanol + 1 L | 150 | 6.67 | 1.83 | 23% |
| | methanol + 8 L | km, | | | |
| | gasoline + 80 mL | 58 | | | |
| | sodium acetate | km/h | | | |
| | solution | | | | |
| 2 | 3 L ethanol + 7 L | 158 | 6.33 | 2.17 | 26% |
| | gasoline + 40 mL | km, | | | |
| | potassium acetate | 58 | | | |
| | solution | km/h | | | |
| 3 | 3 L methanol+7 L | 155 | 6.45 | 2.05 | 24% |
| | gasoline + 20 mL | km, | | | |
| | potassium acetate | 58 | | | |
| | solution + 20 mL | km/h | | | |
| | sodium acetate | | | | |
| | solution | | | | |

### Example 6

The white printing paper was soaked in the potassium acetate solution of Example 5, and then dried under sunlight for two hours. A small piece of the printing paper soaked and a small piece of the printing paper not-soaked in the potassium acetate solution were separately cut off and put on stainless-steel discs (with a thickness of 4 mm), the temperature of which were adjusted to 150° C., 170° C., and 203° C. on an electric furnace in advance. Ignition times of the printing paper were measured. The test results are shown in Table 3, and clearly demonstrate that potassium acetate can promote the combustion of printing paper (resulting in open flames).

Additionally, irregular coconut shell activated carbon particles with a length of approximately 2-3 mm were immersed in the sodium acetate solution of Example 5, and then removed and air-dried. The surface temperature of the stainless-steel disc on the electric furnace was adjusted to approximately 300° C. Both the activated carbon particles coated with sodium acetate and those not coated with sodium acetate were placed on the stainless-steel disc to measure their ignition times. The results show that the ignition time for the sodium acetate-coated activated carbon is 3 seconds, while activated carbon not coated with sodium acetate is 32 seconds. It is evident that sodium acetate accelerates the combustion of activated carbon (producing open flames). The research results indicate that the combustion-promoting technique of the present disclosure is applicable to various combustible materials.

TABLE 3
Ignition time of white printing paper coated with
potassium acetate and not coated with potassium
acetate at different temperatures

| | Ignition | Ignition | Ignition |
|---|---|---|---|
| | time at | time at | time at |
| Sample | 150° C. | 170° C. | 203º C. |
| Printing | Not ignited | Not ignited | 11 seconds |
| paper not | in 60 | in 60 | |
| coated with | seconds | seconds | |
| potassium | | | |
| acetate | | | |
| Printing | Not ignited | Not ignited | 3 seconds |
| paper | in 60 | in 60 | |
| coated with | seconds | seconds | |
| potassium | | | |
| acetate | | | |

The above are only preferred embodiments. It should be noted that, for those of ordinary skill in the art, various modifications and embellishments can be made without departing from the principles of the present disclosure, and these modifications and embellishments should also be considered as falling within the scope of the present disclosure.

What is claimed is:

1. A method for promoting combustion of a combustible while enhancing power output and usage life of the combustion equipment, comprising:
adding an alkali metal element and/or an alkaline earth metal element into the combustible,
wherein a matter state of the combustible comprises at least one selected from the group consisting of gas, liquid, and solid; the alkali metal element comprises one or more selected from the group consisting of Li, Na, K, Rb, Cs, and Fr; and the alkaline earth metal element comprises one or more selected from the group consisting of Be, Mg, Ca, Sr, Ba, and Ra.

2. The method of claim 1, wherein the combustible comprises one or more selected from the group consisting of carbon, a carbon-containing organic matter, ammonia, hydrogen gas, deuterium, tritium, sulfur, phosphorus, a metal, and a ceramic.

3. The method of claim 1, wherein the alkali metal element and/or the alkaline earth metal element is added in a form comprising at least one selected from the group consisting of atom, ion, and plasma; or
the alkali metal element and/or the alkaline earth metal element is added in a form of any matter containing the alkali metal element and/or the alkaline earth metal element; or
the matter containing the alkali metal element and/or the alkaline earth metal element comprises one or more selected from the group consisting of an elementary substance, an alloy, a compound, and a composition containing the alkali metal element and/or the alkaline earth metal element, and a matter state of the matter containing the alkali metal element and/or the alkaline earth metal element comprises one selected from the group consisting of gas, liquid, solid, and plasma.

4. The method of claim 1, wherein the alkali metal element and/or the alkaline earth metal element is added in an amount of 0 wt %-100000.9999999999999999 wt %, but not being 0 wt %, of a mass of the combustible; or
the alkali metal element and/or the alkaline earth metal element is added in an amount of 0 wt %-90.9999999999999999 wt %, but not being 0 wt %, of a mass of the combustible.

5. The method of claim 1, wherein the adding the alkali metal element and/or the alkaline earth metal element into the combustible is conducted by an approach comprising at least one selected from the group consisting of approach I, approach II, approach III, and approach IV, wherein
the approach I comprises: subjecting a matter containing the alkali metal element and/or the alkaline earth metal element to stirring, ball milling, pulverizing, melting, electrical sparking or plasmizating and then adding a resulting material to the combustible; or
mixing a matter containing the alkali metal element and/or the alkaline earth metal element with a noncombustible, and then adding a resulting mixture to the combustible;
the approach II comprises: dissolving a matter containing the alkali metal element and/or the alkaline earth metal element in the combustible;
the approach III comprises: mixing a matter containing the alkali metal element and/or the alkaline earth metal element with a solvent to obtain a solution or a suspension or a paste, and adding the solution, the suspension, or the paste to the combustible; and
the approach IV comprises: adding a matter containing the alkali metal element and/or the alkaline earth metal element into a component of the combustion equipment, wherein the alkali metal element and/or the alkaline earth metal element in the component reacts with the combustible or a noncombustible to generate a substance containing the alkali metal element and/or the alkaline earth metal element and thereby is added to the combustible.

6. The method of claim 5, wherein the component of the combustion equipment in the approach IV is made of a material containing the alkali metal element and/or the alkaline earth metal element; the material containing the alkali metal element and/or the alkaline earth metal element comprises one or more selected from the group consisting of a polymer, a ceramic, and a metal; a content of the alkali metal element and/or the alkaline earth metal element in the material containing the alkali metal element and/or the alkaline earth metal element is in a range of 0 wt %-99.990000000000 wt %, but excluding 0; the component comprises one or more selected from the group consisting of a combustion chamber, a piston, a connecting rod of a piston, a cylinder sleeve, a spray nozzle, a spark plug, a rotor, a blade, a bolt, a nut inside the combustion chamber, a container or a pipeline for a lubricating oil for a combustion chamber, a container or a pipeline of a fuel, a container or a pipeline of a combustion-supporting substance, and a filter; or
in the approach IV, a combustion chamber, or a component of the combustion chamber, a lubricating oil container inside the combustion chamber, a fuel container, a combustion-supporting substance container, a delivery pipeline, or a filter is made of a material containing the alkali metal element and/or the alkaline earth metal element; the combustion chamber or the component of the combustion chamber comprises the combustion chamber, a piston inside the combustion chamber, a connecting rod of a piston, a rotor, and a blade; the material containing the alkali metal element and/or the alkaline earth metal element comprises one or more selected from the group consisting of rubber, a polymer-based composite, a metal, and an alloy; and a content of the alkali metal element and/or the alkaline earth metal element in the alloy is in a range of 0.00000000001 wt %-99.99 wt %.

7. The method of claim 1, wherein a through-hole, a depression, or a protrusion is provided on a surface of a combustion chamber of the combustion equipment or a component of the combustion chamber;
the through-hole, the depression, or the protrusion is of any geometry shape;
the through-hole, the depression, or the protrusion is distributed regularly or irregularly; wherein
the through-hole or the depression is configured as a storage of a matter containing the alkali metal element and/or the alkaline earth metal element to add the matter containing the alkali metal element and/or the alkaline earth metal element into the combustible to avoid deficiency or content fluctuation of the alkali metal element and/or the alkaline earth metal element in the combustible during combustion;
the through-hole, the depression, or the protrusion releases different matters containing the alkali metal element and/or the alkaline earth metal element to adjust chemical composition and structure of matters containing the alkali metal element and/or the alkaline earth metal element in different spaces inside the combustion chamber, so as to further adjust combustion state in different spaces inside the combustion chamber to further improve combustion efficiency.

8. The method of claim 1, wherein the matter containing the alkali metal element and/or the alkaline earth metal element, or the combustible containing the matter containing the alkali metal element and/or the alkaline earth metal element, or a noncombustible containing the alkali metal element and/or the alkaline earth metal element is added to a fuel of the combustion equipment.

9. The method of claim 1, wherein the combustion equipment comprises one selected from the group consisting of: internal combustion engines, external combustion engine, piston engine, turbofan engine, turbojet engine, rocket engine, gas turbine, boiler, nuclear fusion reactor, nuclear fission reactor, fuel cell, stove, warmer, oven, thermoelectric conversion device, and heat-cold conversion device; or
the combustion equipment comprises one or more selected from the group consisting of a primary combustion equipment and a secondary combustion equipment that utilizes an exhaust gas of a primary combustion equipment; and the primary combustion equipment comprises one or more selected from the group consisting of: gasoline engine, diesel engine, gas piston engine, jet engine, rocket engine, gas turbine, boiler, and thermoelectric conversion device; and the secondary combustion equipment that utilizes the exhaust gas of the primary combustion equipment comprises boiler, industrial kiln, thermoelectric conversion device, refrigeration device, and heat-cold conversion device.

10. The method of claim 1, wherein a component or a part of the component of the combustion equipment is provided with a through-hole, a depression, or a protrusion;
there is or is not a protrusion in the depression;
the depression or the protrusion is arranged regularly or irregularly;
the depression, the protrusion, or the through-hole is of any geometry shape; and
the component comprises one or more selected from the group consisting of a combustion chamber or a component inside the combustion chamber.

11. The method of claim 10, wherein an orifice of the through-hole, an opening of the depression, or a base of the protrusion has a maximum cross-sectional area of 0.01 nm² to 1 m²; and
a depth of the depression or a height of the protrusion is in a range of 0.1 nm to 100 mm.

12. The method of claim 10, wherein the component or the part of the component of the combustion equipment is made of a material containing the alkali metal element and/or the alkaline earth metal element;
a content of the alkali metal element and/or the alkaline earth metal element in the material containing the alkali metal element and/or the alkaline earth metal element is in a range of 0 wt %-99.990000000000 wt %, but excluding 0;
the material containing the alkali metal element and/or the alkaline earth metal element comprises one selected from the group consisting of a polymer, a metal, and a ceramic; and
the component comprises one or more selected from the group consisting of a combustion chamber or a component inside the combustion chamber, a pipeline or a container for a lubricating oil for the combustion chamber, a pipeline or a container for a fuel, a pipeline or a container of a combustion-supporting material, and a filter.

13. The method of claim 1, wherein the combustion equipment is a piston engine; and
a depression is provided on an inner surface of a cylinder of the piston engine; an opening of the depression has a surface area of 0.01 nm² to 0.03 m²; and a depth of the depression is in a range of 0.1 nm to 50 mm.

14. The method of claim 13, wherein there is a depression or a protrusion on an outer surface of the cylinder; an opening of the depression or a base of the protrusion has a surface area of 0.01 nm² to 0.03 m²; and a depth of the depression or a height of the protrusion is in a range of 0.1 nm to 50 mm; or
there is a groove and/or a blind hole on the inner surface of the cylinder; a width of the groove or a diameter of the blind hole is in a range of 0.001 μm to 10 mm; and a depth of the groove or the blind hole is in a range of 0.001 μm to 10 mm.

15. The method of claim 13, wherein a component or a part of the component of the piston engine is made of a material containing the alkali metal element and/or the alkaline earth metal element; a content of the alkali metal element and/or the alkaline earth metal element in the material containing the alkali metal element and/or the alkaline earth metal element is in a range of 0 wt % to 99.990000000000 wt %, but excluding 0 wt %; the material containing the alkali metal element and/or the alkaline earth metal element comprises one selected from the group consisting of a polymer, a metal, and a ceramic; and the component comprises one or more selected from the group consisting of: a combustion chamber, a component inside the combustion chamber, a container or a pipeline for a lubricating oil for the combustion chamber, a container or a pipeline for a fuel, a container or a pipeline for a combustion-supporting material, and a filter.

16. The method of claim 13, wherein the piston engine comprises or does not comprise a liquid cooling system; the combustible used for the piston engine comprises one or more selected from the group consisting of: gasoline, diesel, bio-diesel, a plant oil, an animal oil, bio-ethanol, bio-methanol, ethanol, methanol, ammonia, hydrogen gas, natural gas, acetylene, methane, liquefied petroleum gas, a polymer-based carbon-containing organic matter, and a plant-based carbon-containing organic matter; or
the piston engine has or does not have a liquid cooling system; the piston engine has a naturally aspirated system, or a high-pressure intake system; and the piston engine comprises or does not comprise an external forced lubrication system.

17. A fuel, comprising: a combustible and an alkali metal element and/or an alkaline earth metal element;
a mass of the alkali metal element and/or the alkaline earth metal element is 0 wt % to 100000.9999999999999999 wt %, not being 0 wt %, of a mass of the combustible; and
a matter state of the combustible comprises at least one selected from the group consisting of gas, liquid, and solid; the alkali metal element comprises one or more selected from the group consisting of Li, Na, K, Rb, Cs, and Fr; and the alkaline earth metal element comprises one or more selected from the group consisting of Be, Mg, Ca, Sr, Ba, and Ra.

18. The fuel of claim 17, wherein a content of the alkali metal element and/or the alkaline earth metal element is 0 wt % to 90.9999999999999999 wt %, not being 0 wt %, of the mass of the combustible; or
the fuel comprises anti-explosive fuel, internal combustion engine fuel, external combustion engine fuel, piston engine fuel, mixed fuel engine fuel, mixed fuel, turbofan engine fuel, turbojet engine fuel, gas turbine fuel, boiler fuel, fuel cell fuel, nuclear fusion fuel, nuclear fission fuel, warmer fuel, oven fuel, thermoelectric conversion device fuel, and heat-cold conversion device fuel.

19. A high-efficiency fuel energy conversion system, comprising: combustion of a combustible with addition of an alkali metal element and or an alkaline earth metal element in a combustion equipment,
wherein a mass of the alkali metal element and/or the alkaline earth metal element is 0 wt % to 100000.9999999999999999 wt %, not being 0 wt %, of a mass of the combustible; and
a matter state of the combustible comprises at least one selected from the group consisting of gas, liquid, and solid; the alkali metal element comprises one or more selected from the group consisting of Li, Na, K, Rb, Cs, and Fr; and the alkaline earth metal element comprises one or more selected from the group consisting of Be, Mg, Ca, Sr, Ba, and Ra.

20. A use method of the high-efficiency fuel energy conversion system of claim 19, comprises: adding the alkali metal element and/or the alkaline metal element into the combustible.
